(19) United States
(12) Patent Application Publication
(10) Pub. No.: US 2004/0265659 A1
(43) Pub. Date: Dec. 30, 2004

(54) Pressure control system for fuel cell gas spring

(76) Inventors: Curtis A. Richardson, Voorheesville, NY (US); Michael J. Yax, Rochester, NY (US)

Correspondence Address: DELPHI TECHNOLOGIES, INC., M/C 480-410-202, PO BOX 5052, TROY, MI, 48007, US

(21) Appl. No.: 10/606,850

(22) Filed: Jun. 26, 2003

(51) Int. Cl. H01M 8/04; H01M 8/00; H01M 8/12

(52) U.S. Cl. 429/25; 429/22

(57) ABSTRACT

In a fuel cell assembly, a passive gas spring is disposed between the stack and the supporting structure for maintaining compressive force on the stack and manifold seal. As variation in temperature of the assembly and structure causes dimensional changes therein, the pressure within the gas spring also changes accordingly. The gas spring is provided with inlet and outlet check valves, the outlet check valve opening to expel air when internal spring pressure reaches a predetermined upper pressure limit, and the inlet check valve opening to admit air when the internal spring pressure falls below a predetermined lower pressure limit in a currently preferred embodiment, the outlet check valve allows exit of gas from the gas spring at pressures exceeding 5 psig, to prevent rupture of the gas spring, and the inlet check valve allows entrance of gas into the gas spring as the spring cools following use.

### TECHNICAL FIELD

The present invention relates to hydrogen/oxygen fuel cells; more particularly, to method and apparatus for applying a compressive load to a fuel cell stack assembly and supply manifold during manufacture and for maintaining a compressive load thereupon during use; and most particularly, to method and apparatus for automatically venting and refilling a gas spring during use thereof to maintain pressures within the spring within a predetermined range.

### BACKGROUND OF THE INVENTION

Fuel cells which generate electric current by controllably combining elemental hydrogen and oxygen are well known. In one form of such a fuel cell, an anodic layer and a cathodic layer are deposited on opposite surfaces of a permeable electrolyte formed of a ceramic solid oxide. Such a fuel cell is known in the art as a “solid oxide fuel cell” (SOFC). Hydrogen, either pure or reformed from hydrocarbons, is flowed along the outer surface of the anode and diffuses into the anode. Oxygen, typically from air, is flowed along the outer surface of the cathode and diffuses into the cathode where it is ionized. The oxygen ions diffuse through the electrolyte and combine with hydrogen ions to form water. The cathode and the anode are connected externally through the load to complete the circuit whereby electrons are transferred from the anode to the cathode. When hydrogen is derived from “reformed” hydrocarbons, the reformate gas includes CO which is converted to CO₂ at the anode. Reformed gasoline is a commonly used fuel in automotive fuel cell applications.

A single cell is capable of generating a relatively small voltage and wattage, typically between about 0.5 volt and about 1.0 volt, depending upon electrical load, and less than about 2 watts per cm² of cell surface. Therefore, in practice it is usual to stack together, in electrical series, a plurality of cells.

Because each anode and cathode must have a free space for passage of gas over its surface, the cells are separated by perimeter spacers which are vented to permit flow of gas to the anodes and cathodes as desired but which form seals on their axial surfaces to prevent gas leakage from the sides of the stack. The perimeter spacers include dielectric layers to insulate the interconnects from each other. Adjacent cells are connected electrically by “interconnect” elements in the stack, the outer surfaces of the anodes and cathodes being electrically connected to their respective interconnects by electrical contacts disposed within the gas-flow space, typically by a metallic foam which is readily gas-permeable or by conductive filaments. The outermost, or end, interconnects of the stack define electric terminals, or “current collectors,” which may be connected across a load.

A complete SOFC assembly typically includes auxiliary subsystems for, among other requirements, generating fuel by reforming hydrocarbons; tempering the reformate fuel and air entering the stack; providing air to the hydrocarbon reformer; providing air to the cathodes for reaction with hydrogen in the fuel cell stack; providing air for cooling the fuel cell stack; providing combustion air to an afterburner for unspent fuel exiting the stack; and providing cooling air to the afterburner and the stack. These various subsystems typically are mated via mounting to an integrating manifold. A complete SOFC assembly also includes appropriate piping and valving, as well as a programmable electronic control unit (ECU) for managing the activities of the subsystems simultaneously.

During assembly of a fuel cell stack, a compressive load must be maintained during high-temperature sintering of the stack assembly seals. Desirably, a light compressive load is maintained after the sintering process to ensure the integrity of the glass seals to the manifold during assembly and also afterwards during use of a finished fuel cell assembly.

The stack assembly is made from a variety of metallic and non-metallic materials, and the supporting structure fastening the stack to its manifold is constructed of, typically, a bolting material capable of withstanding high temperatures. At operating temperature, typically around 800° C., thermal growth of the stack does not match thermal growth of the bolting material because of differences in thermal expansion coefficients, which mismatch can result in loss of compressive load against the various seals.

To compensate for this mismatch, it is known to use springs within the assembly. However, high operating temperatures can affect temper of spring materials, resulting in load failure. Further, spring constants typically diminish with increase in temperature, conditions under which an increase in spring force is desirable to compensate for increasing mismatch.

Further, a fuel cell assembly may comprise a plurality of fuel cell stacks disposed side-by-side within a single supporting structure, and different stacks may vary in height at different temperatures.

Therefore, a gas-filled pillow or gas spring may be used within the assembly, the gas being thermally expandable to ensure excellent sealing of the elements as the temperature of a fuel cell assembly is increased during seal sintering and operation.

A problem arises with gas springs, however, in that the differential between ambient temperature, e.g., 20° C., and sintering or operating temperature, e.g., 800-1000° C. is very large. A gas spring filled to ambient pressure (0 psig) at ambient temperature exhibits pressures at elevated temperatures far in excess of what is needed to provide reliable sealing, e.g., 5 psig. Further, such high pressure can be sufficient to cause rupture of the gas spring and consequent failure of the fuel cell assembly.

What is needed is a means for providing a compressive load to a fuel cell assembly at ambient and elevated temperatures to compensate for mismatches in the heights of multiple stacks and for the difference in thermal expansion between the stacks and the supporting structure, and further, means for maintaining such compressive load within a predetermined pressure range.

It is a principal object of the present invention to compress a fuel cell assembly automatically within a predetermined range of pressures under all required temperature conditions during manufacture and use.

### SUMMARY OF THE INVENTION

Briefly described, in a fuel cell assembly comprising one or more fuel cell stacks and a supporting structure, a passive gas spring is disposed between the stacks and the supporting structure for maintaining compressive force on the stack and manifold seals. The spring includes a membrane formed of a metal alloy stable at the operating temperatures required of the fuel cell assembly. As variation in temperature of the assembly and structure causes dimensional changes therein, the pressure within the gas spring also changes accordingly. The gas spring is provided with inlet and outlet check valves, the outlet check valve opening to expel air when internal spring pressure reaches a predetermined upper pressure limit, and the inlet check valve opening to admit air when the internal spring pressure falls below a predetermined lower pressure limit. Internal pressure is thereby automatically controlled within a predetermined range of operating pressures, thus maintaining a compressive load on the fuel cell stack over the full range of temperature variation.

In a currently preferred embodiment, the outlet check valve allows exit of gas from the gas spring at, preferably, pressures exceeding 5 psig, to prevent rupture of the gas spring; and the inlet check valve allows entrance of gas into the gas spring as the spring cools following use. Entrance air may be pressurized in known fashion to maintain a slight positive pressure in the spring, or the inlet check valve may open in response to ambient air pressure, so that the gas spring begins a thermal cycle at 0 psig.

An advantage of the present invention is that a suitable maximum gas pressure may be provided in a gas spring at elevated temperature without concomitantly creating a negative gas pressure in the spring at ambient temperature.

### BRIEF DESCRIPTION OF THE DRAWINGS

The present invention will now be described, by way of example, with reference to the accompanying drawings, in which:

FIG. 1 is a schematic drawing, showing a gas spring having inlet and exhaust check valves, in accordance with the invention;

FIG. 2 is an elevational cross-sectional view of a portion of a gas spring, showing incorporation of an inlet check valve; and

FIG. 3 is an elevational cross-sectional view of a fuel cell stack assembly including the gas spring shown in FIG. 2.

### DESCRIPTION OF THE PREFERRED EMBODIMENTS

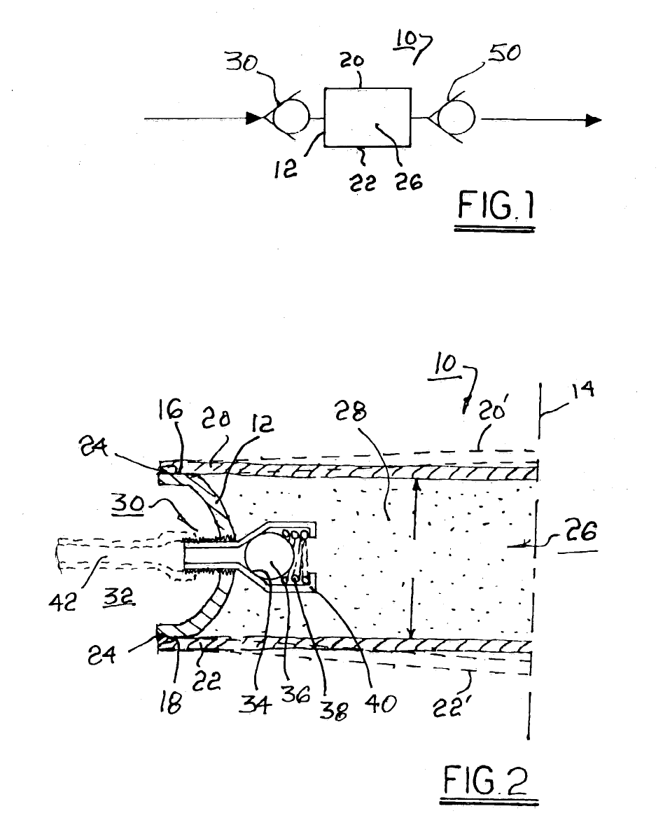

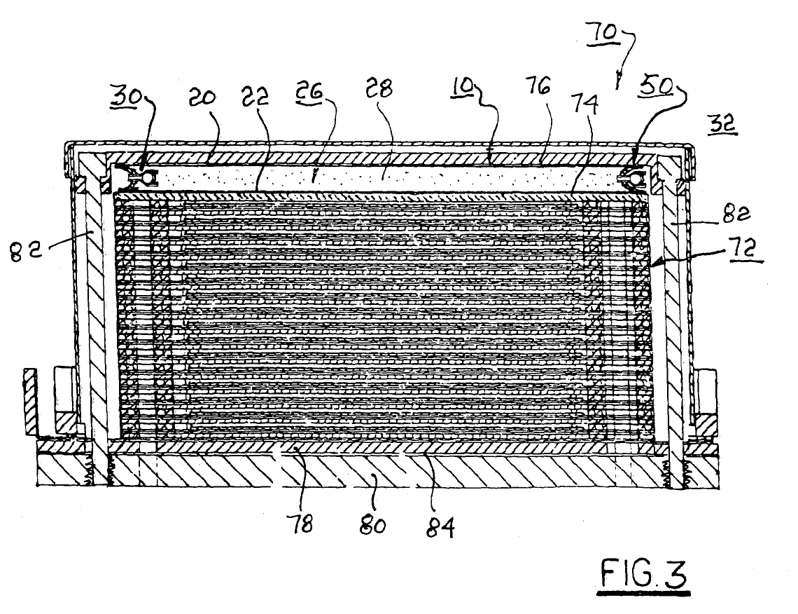

Referring to FIGS. 1 and 2, in accordance with the invention, a novel gas spring 10 comprises a closed frame element 12 having axis 14. Element 12 preferably is formed in a trough shape to resist radial deformation under load and may be radially concave or convex to equal effect. Frame element 12 includes first and second axial surfaces 16,18 to which at least one flexible membrane, and preferably first and second membranes 20,22, respectively, is continuously attached as by laser welding 24 to form a flattened pillow defining a chamber 26. Preferably, membranes 20,22 are formed of a flexible high-temperature metal alloy, for example, Haynes 160, 214, 230, 825, or 901; a Hasteloy; or Inconel DS, 625, or 718. Preferably, membranes 20,22 are between about 0.005 inch and 0.010 inch in thickness. Chamber 26 is filled with a gas 28, preferably air, which may be installed in known fashion at any desired pressure and temperature above or below atmospheric and ambient for any specific application; one atmosphere at ambient temperature is currently preferred for fuel cell uses.

Gas spring 10 further includes a first check valve 30 exemplarily disposed in element 12 via a first threaded opening therein. Valve 30 thus communicates between the exterior 32 of spring 10 and chamber 26. Valve 30 may comprise any convenient check valve design as may be known in the art of check valves.

As shown herein, valve 30 includes a tapered valve seat 34, a check ball 36, and a spring 38 retained by cage 40. Valve 30 is oriented to admit gas into chamber 26 when pressure in exterior 32 exceeds the combined pressure of gas 28 in chamber 26 plus the force of spring 38. In a currently preferred embodiment, the force of spring 38 is very nearly zero, about 0.1 psig, sufficient to maintain ball 36 in place on seat 34; thus, the lower operating limit of gas spring 10 is about 1 atmosphere, or 0 psig. Of course, if higher minimum pressures are desired, a source 42 of gas at the desired pressure may be connected to valve 30, as shown in phantom in FIG. 2.

Referring to FIGS. 2 and 3, gas spring 10 further includes a second check valve 50 exemplarily disposed in element 12 via a second threaded opening therein. Valve 50 thus communicates between the exterior 32 of spring 10 and chamber 26. Valve 50 may comprise any convenient check valve design as may be known in the art of check valves and preferably is substantially identical to first check valve 30. Valve 50 is oriented to vent gas from chamber 26 when the pressure of gas 28 in chamber 26 exceeds the predetermined force of the valve spring. In a currently preferred embodiment for use with a fuel cell assembly, the force of the spring is selected such that gas is vented from chamber 26 at about 5 psig.

It will be obvious to one of ordinary skill in the art that first and second check valves 30,50 may be installed, within the scope of the invention, at any of many locations in gas spring 10, not only in element 12 but in membranes 20,22 as well. Further, gas springs in accordance with the invention may be formed for use in some applications by omitting frame element 12 entirely and directly sealing membrane 20 to membrane 22 as by laser welds to form a gas-filled pillow.

Still referring to FIG. 3, gas spring 10 is beneficially employed in a solid-oxide fuel cell assembly 70 to generate axial pressure on fuel cell stack 72. As the temperature of captive gas 28 rises, increased outward pressure is exerted on element 12 and membranes 20,22 in accordance with Boyle's Law, urging the membranes apart axially as shown by phantom membranes 20′,22′ in FIG. 2. When installed in assembly 70, membranes 20,22 are restrained by spring holder 74 and spring retaining plate 76. Thus, thermal expansion of gas spring 10 urges spring holder 74 toward base plate 78, keeping stack 72 under compression, and urges retaining plate 76 away from manifold 80, thus keeping bolts 82 under tension and seal 84 under compression.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A gas spring system having a spring force variable with temperature, comprising:
a) a first membrane;
b) a second membrane;
c) means for sealing edges of said first and second membranes to define a closed chamber therebetween for capture of gas;
d) first valve means for admitting gas to said chamber; and
e) second valve means for exhausting gas from said chamber.

2. A gas spring system in accordance with claim 1 wherein said means for sealing includes direct sealing of said first membrane to said second membrane to form a gas-filled pillow.

3. A gas spring system in accordance with claim 1 wherein said means for sealing includes a rigid frame element disposed between said first and second membranes.

4. A gas spring system in accordance with claim 3 wherein said frame element has a trough-shaped cross section.

5. A gas spring system in accordance with claim 4 wherein said trough shape is radially concave.

6. A gas spring system in accordance with claim 4 wherein said trough shape is radially convex.

7. A gas spring system in accordance with claim 1 wherein said first valve means is a check valve.

8. A gas spring system in accordance with claim 7 wherein said check valve is closed at all pressures across said valve exceeding about 0.1 psig.

9. A gas spring system in accordance with claim 1 wherein said second valve means is a check valve.

10. A gas spring system in accordance with claim 9 wherein said check valve is closed at all pressures across said valve less than about 5 psig.

11. A fuel cell assembly, comprising:
a) at least one fuel cell stack;
b) a supporting structure surrounding said fuel cell stack; and
c) a gas spring disposed within said assembly between said stack and said supporting structure, said spring including a first membrane, a second membrane, means for sealing edges of said first and second membranes to define a closed chamber therebetween for capture of gas, first valve means for admitting gas to said chamber, and second valve means for exhausting gas from said chamber.

12. A fuel cell assembly in accordance with claim 11 wherein said fuel cell stack includes at least one solid-oxide fuel cell.

13. A fuel cell assembly comprising:
a) at least one fuel cell stack;
b) a supporting structure surrounding said fuel cell stack; and
c) gas spring means disposed within said assembly between said stack and said supporting structure, said gas spring means defining a closed chamber and including an inlet valve for admitting gas into said chamber and an outlet valve for exhausting gas from said chamber.
